(19) United States
(12) Patent Application Publication
(10) Pub. No.: US 2006/0007081 A1
(43) Pub. Date: Jan. 12, 2006

(54) Driving method for LCD panel

(76) Inventors: Liang-Chen Chien, Chu-Pei City (TW); Cheng-Jung Chen, Maio-Li Hsien (TW); Chang-Cheng Lin, Taipei (TW)

Correspondence Address: SUPREME PATENT SERVICES, POST OFFICE BOX 2339, SARATOGA, CA, 95070, US

(21) Appl. No.: 10/889,265

(22) Filed: Jul. 10, 2004

(51) Int. Cl. G09G 3/36

(52) U.S. Cl. 345/87

(57) ABSTRACT

A driving method for LCD panel is disclosed, wherein the driver circuit includes multiple data line drivers and at least two gate line drivers, and the first gate line driver produces a normal image with sequential line scanning starting from one area, and, the second gate line driver produces a dimmed image starting from anther area at the same time, but a predetermined number of unused lines are always maintained in between, until all the gate lines are finished to emulate one full sweep across the CRT. Therefore, a dimmed image is inserted into every digitized image, where a dimmed image is defined to be a digitized image with a fraction 1/N of the original pixel value. The LCD panel drive using this driving method can be brought much closer to the impulse approach used in CRT displays, and the flickering phenomenon can be significantly rectified.

### BACKGROUND OF THE INVENTION

1. Field of the Invention

The present invention relates to a driving method for liquid crystal display (LCD) panel, and in particular to a method for driving LCD panel by alternately displaying a dimmed image and a normal image in a single frame, so that image display on LCD can be brought closer to the impulse approach used in cathode ray tube (CRT) displays, and the flickering phenomenon can be significantly rectified.

2. The Related Art

One effective method of improving the video display performance of and correcting the usual after-image phenomenon on LCD panels is to use pseudo-impulse drive (PID) technology, which enables the digitized image to more closely approach the impulse-emission of the CRT. Referring to FIGS. 1A-1C, the current method of pseudo impulse drive employs alternate display of a normal image 10 and an all-black image 20 to emulate the impulse emission of the CRT.

A selection rule is defined for selection from at least two gate line drivers of the PID, one of which is selected as the first gate line driver and another as the second gate line driver, such that the first and second gate line drivers alternately output a normal image 10 and an all-black image 20 in a single frame.

The first gate line driver starts to scan from the first line to the eleventh line one line at a time sequentially downward, as shown in FIG. 1A, to produce a normal image 10, and, after 240 lines are skipped, the second gate line driver starts to scan from the 241st line down to the 251st line sequentially downward, as shown in FIG. 1B, to produce an all-black image 20 until the bottom is reach. Thereafter, the first and second gate line drivers are switched to the positions of the other; that is the first gate line driver then continues with the normal image 10 from the 241st line, and the second gate line driver then continues with the all-black image 20 from the 1st line as shown in FIG. 1C, and the line scanning proceeds in such manner until all gate lines connected to the first and second gate line drivers are used, thus emulating a full sweep across the display screen.

As shown in FIG. 1C, before part of the normal image 10 is displayed, the gates lines starting from the 241st line were first used to display part of an all-black image 20 as shown in FIG. 1A, so the drive voltage of all pixels on the 241st line and following lines has been restored to non-emission state after the all-black image 20. Therefore, when the first gate line driver starts the line scanning from the 241st line to produce part of the normal image 10, the pixels of the 241st line and lines following undergo a voltage change very much like the impulse emission of the CRT, to more closely emulate the impulse drive of the CRT.

However, if the refresh rate of the LCD panel is only 60 Hz, using the above PID method to drive an LCD panel, the high-speed switching between all-black images 20 and normal images 10 could easily produce flickering phenomenon to the human eyes. Further, the all-black image 20 could be inserted before the normal image 10, thus affecting the brightness of the LCD panel by as much as 50%. Therefore, if the conventional PID method is used to drive a LCD panel, it is necessary to use a backlight source of higher luminescent efficiency.

### SUMMARY OF THE INVENTION

The primary objective of the present invention is to provide a driving method for LCD panel that is able to avoid the flickering of the digitized image as compared with the prior art method.

The secondary objective of the invention is to provide a driving method for LCD panel that is able to avoid any degradation of the brightness of the LCD as compared with prior art PID method, making it unnecessary to use a backlight source of higher luminescent efficiency.

To this end, the driver circuit in accordance with the present invention employs multiple data line drivers and at least two gate line drivers, where one of the two gate line drivers is to be the first gate line driver, and the other one to be the second gate line driver, wherein the first gate line driver is positioned to start line scanning from the p_line one line at a line and sequentially downward for a predetermined range to produce a normal image, and, after skipping over a predetermined number of lines, the second gate line driver is positioned to scan from the q_line sequentially downward for a predetermined range to produce a dimmed image in the same frame; then the first and second gate line drivers are switched to the positions of the other, that is the second gate line driver is to continue with the normal image from the p_line and the first gate line driver is to continue with the dimmed image from the q_line, and the line scanning proceeds in such manner until all gate lines connected by the first and second gate line drivers are used, thus emulating one full sweep across the display screen; wherein when one line of the normal image in a single frame is scanned, a line of the dimmed image is also scanned simultaneously, where the dimmed image is defined to be a digitized image in the current frame with only 1/N of the original pixel value.

The present invention will become more obvious from the following description when taken in conjunction with the accompanying drawings, which show, for purposes of illustration only, several embodiments in accordance with the present invention.

### BRIEF DESCRIPTION OF THE DRAWINGS

FIGS. 1A-1C depict the conventional method of driving LCD panel with Pseudo Impulse Drive;

FIGS. 2A-2C depict the driving method of the present invention to emulate impulse-emission of the CRT;

FIG. 3 is another variation of the above driving method; and

FIGS. 4A-4B illustrate two examples using a dimmer signal in the data line driver.

### DETAILED DESCRIPTION OF THE PREFERRED EMBODIMENT

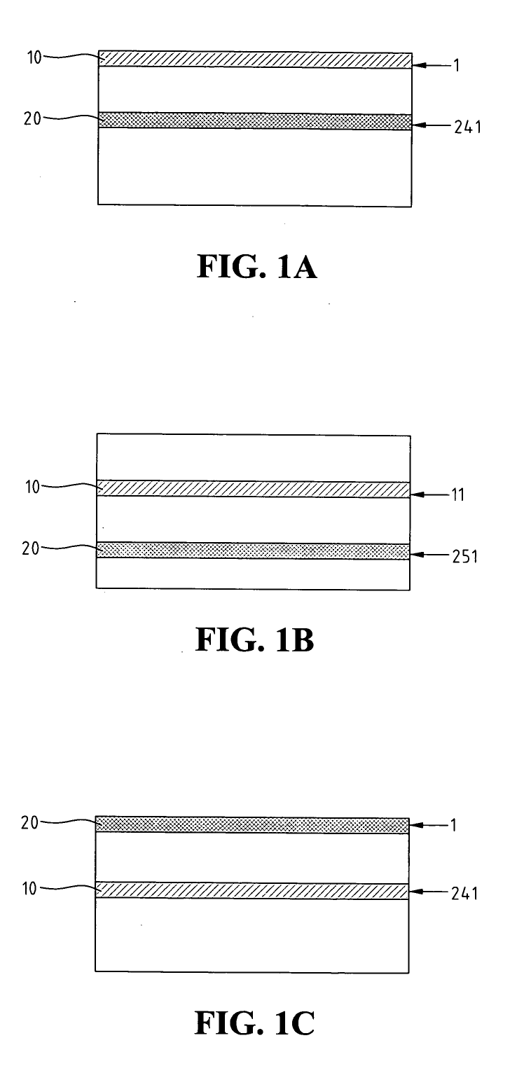

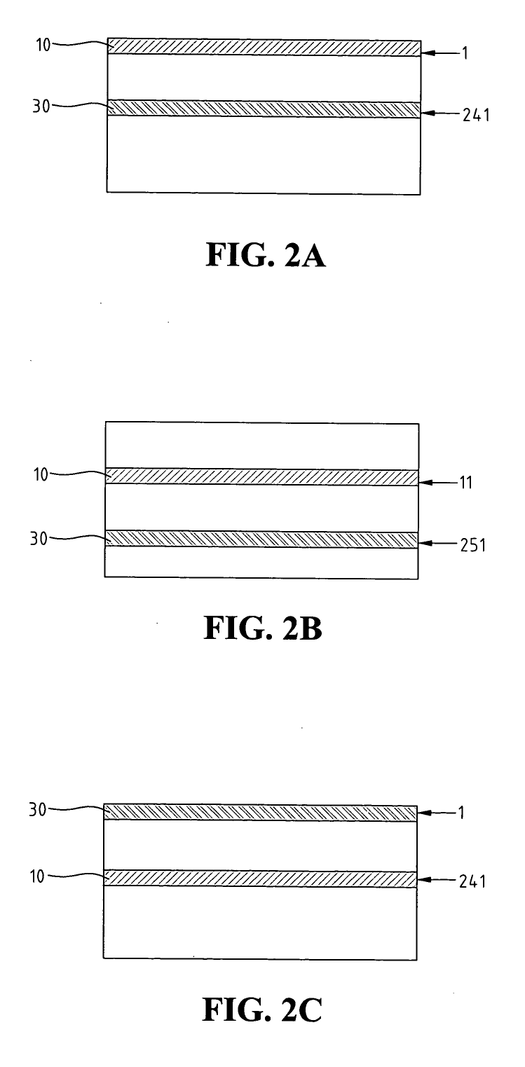

The driving method for LCD panel in accordance with the present invention is illustrated through FIGS. 2A-2C, in which the all-black image 20 shown in FIGS. 1A-1C is replaced by a dimmed image 30, where a dimmed image 30 is defined to be a digitized image being displayed in a single frame with 1/N of the original pixel value and N is a positive integer, while other components of the driver circuit are similar to those currently used to implement pseudo impulse drive, but using this method the brightness and flickering phenomena are improved significantly.

Specifically, to display a dimmed image 30 starting from the 1st line as shown in FIG. 2C, the pixel value of a dimmed image 30 in accordance with the invention, needs to be derived from the pixel value of the normal image 10 also starting from the 1st line as shown in FIG. 2A after multiplying the original pixel value by a fraction 1/N, where N is a positive integer. If the value of N gets larger, the dimmed image 30 will come closer to the all-black image 20; conversely, if the value of N becomes smaller, the dimmed image 30 will resemble the LCD display using the hold circuit. Therefore, it is necessary to set the N value appropriately so as to be able to produce LCD display performance better than that using a hold circuit, while the flickering and brightness phenomena can be controlled without using the all-black image 20.

Basing on a given selection rule, the gate line driver that works with the data line driver to output the drive voltage for a normal image in a single frame is to be a first gate line driver, whereas the gate line driver that works with the data line driver to output the drive voltage for a dimmed image in the current frame is to be a second gate line driver.

When a drive voltage is asserted on the data lines by the data line drivers 70, the first gate line driver connected to the corresponding gate lines is to produce a normal image 10 of a single frame on the LCD panel by scanning the gate lines, and the second gate line driver is to produce a dimmed image 30 in the current frame by scanning the same number of gate lines.

If the resolution of a LCD panel is given to be 640×480, the first gate line driver produces a normal image 10 starting from the 1st line downward as shown in FIG. 2A, and, after skipping over 240 lines, the second line driver simultaneously inserts a dimmed image 30 starting from the 241st line downward in the current frame as shown in FIG. 2B; thereafter, the first and second gate line drivers are switched to the positions of the other, that is the second gate line driver continues with the dimmed image 30 up from the 1st line sequentially downward, as shown in FIG. 2C, and the first gate line driver continues with the normal image 10 down from the 241st line sequentially downward, wherein when one line of the normal image 10 is being scanned on one part of the frame, a line of the dimmed image 30 is also scanned simultaneously on another part of the frame; and the line scanning proceeds in such manner until all the gate lines connected by the first and second gate line drivers are used to produce the normal image 10 and the dimmed image 30, thus emulating one full sweep across the display screen.

From the foregoing, it is apparent that the present invention is related to a driving method for LCD panels that is able to use the dimmed image 30 to replace the all-black image 20 of the prior art. The main advantage is that the dimmed image 30 can be obtained from appropriate modulation of the digitized image by multiplying the pixel value of the digitized image by a fraction 1/N, without having to produce the all-black image 20. Also, this method can avoid the usual flickering phenomenon and the degradation of brightness associated with the conventional PID. Therefore, it is unnecessary to use backlight source with higher luminescent efficiency and the driver costs can thus be lowered considerably.

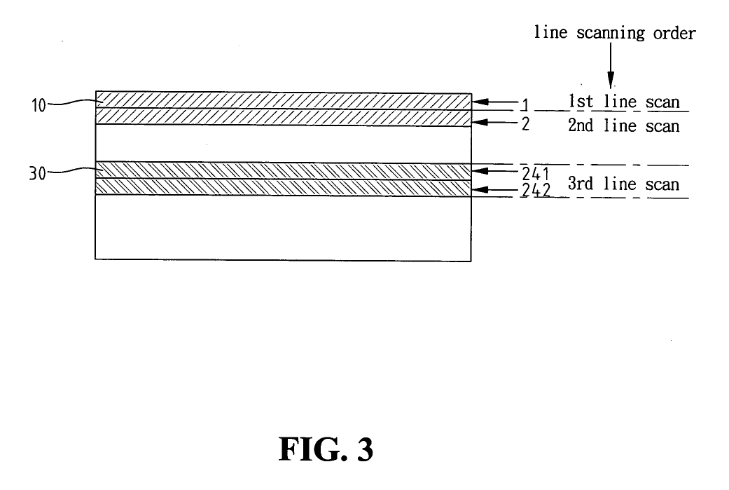

Referring to FIG. 3, the diagram depicts another variation of the invention, wherein the driving method is different from the previous example in that two lines are scanned at one time by the gate line driver, as compared with the previous example illustrated in FIGS. 2A-2C. The first gate line driver is to produce a normal image 10 from the 1st line one line at a time for two scan lines consecutively, as shown in FIG. 3; then, the second gate line driver, after skipping over 240 lines, is to produce a dimmed image 30 by scanning the 241st and 242nd lines both at the same time. In other words, the order of line scanning starts with the 1st line, then the 2nd line, and then the 241st and 242nd lines, and subsequently the line scanning proceeds in the same manner to finish the normal image 10 and the dimmed image 30 to be displayed on the LCD panel.

When compared with FIG. 2A, if two lines are scanned at one time, starting with the pair of 241st and 242nd lines, to produce the dimmed image 30, it is possible to use three vertical clock signals in this case to finish scanning the 1st line, the 2nd line, the 241st and 242nd lines, whereas in the previous example shown in FIG. 2A, four vertical clock signals are required. Theoretically, if the number of scan lines at one time is increased, the required clock signals can be tightened. It shall be noted that the maximum number of scan lines at one time shall be no more than the fixed number of gate lines connected to the gate line drivers, so if the number of scan lines at one time is increased to match the fixed number of gate lines, the required number of clock signals will come close to a conventional LCD.

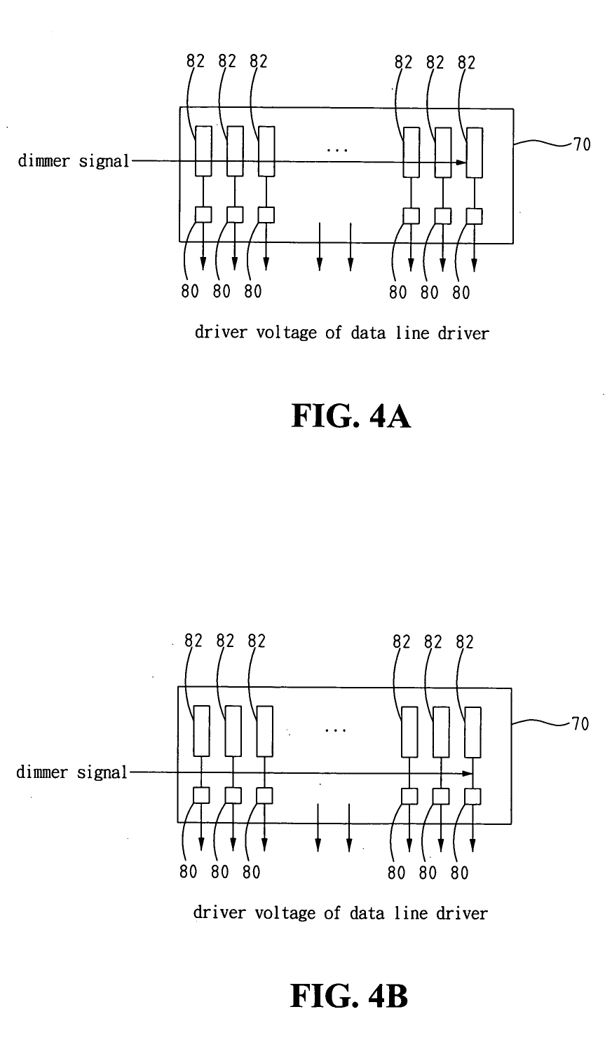

Referring to FIGS. 4A-4B, a dimmer signal is introduced in the data line driver. A conventional data line driver 70 includes several digital-to-analog converters (DACs) 80 and data registers 82. The resolution of an LCD panel determines the number of data line drivers 70 for connecting the required number of data lines and the same requirements for DACs 80 and data registers 82.

According to the present invention, the driving method is to insert a dimmed image 30 for every normal image 20 created in a single frame, so the line scanning frequency of the data line driver 70 needs to be twice that of the conventional data line driver, and the data channel width also needs to be increased for accommodating the normal image 10 and the dimmed image 30. However, increased scanning frequency will generate undesirable electromagnetic interference (EMI). The present solution is to connect the data line drivers 70 to a dimmer control line, so when a dimmer signal is received the digitized image temporarily saved in the data registers will be modulated to produce the required dimmed image 30, so as to avoid the increase of line scanning frequency for the data line driver 70.

In one implementation, as shown in FIG. 4A, the dimmer control line is connected to the data registers 82. When the data line driver 70 intends to produce the drive voltage for a dimmed image 30, a dimmer signal is issued to the data registers 82 of the data line drivers 70, so the digitized image temporarily saved in the data registers 82 is modulated, such that the pixel value of the digitized image is changed to a fraction 1/N of the original pixel value. Therefore, when the modulated digital signals are eventually passed to the DACs 80, the drive voltage output by the data line drivers 70 is able to match the required dimmed image 30, so it is not necessary to produce or save the dimmed image 30 in the data registers 82.

In another implementation, as shown by FIG. 4B, the dimmer control line is connected between the data registers 82 and the DACs 80. When the data line driver 70 intends to output the drive voltage for a dimmed image 30, all data registers 82 and DACs 80 receive a dimmer signal, and these components will cause a certain change in the digital signals to be output to the DACs 80, such that the pixel value of the digitized image is to be changed to 1/N of the original pixel value. After the modulated digital signals are passed to the DACs 80, the drive voltage output by the data line drivers is to match the required dimmed image 30. Therefore, the introduction of the dimmer signal makes it unnecessary to first save the dimmed image 30 in data registers 82 according to these two implementations.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A driving method for LCD panels:
wherein the related driver circuit employing the driving method includes: multiple data line drivers and at least two gate line drivers, where the data line drivers and gate line drivers are respectively connected to multiple data lines and gate lines of LCD panel, and a pixel is defined as one element of a digitized image positioned in an overlapping area between a data line and a gate line, such that when a drive voltage is asserted on an associated data line by a data line driver, and a gate pulse is generated on an associated gate line by a gate line driver, selected pixel is to display one element of a digitized image on the LCD panel through the line scanning process,
basing on a selection rule one of the two gate line drivers is selected as first gate line driver, which is to produce a normal image in a single frame by scanning from the p_line one line at a time sequentially downward, and then the first gate line driver is repositioned down on the lower half of the frame, after skipping over a predetermined number of lines in between and continues line scanning from the q_line, until all gate lines in a single frame are used; and
basing on the selection rule another one of the two gate line drivers is selected as second gate line driver, which is to produce a dimmed image on the lower half of the frame starting from q_line one line at a time sequentially downward, after skipping over a predetermined number of lines between the p_line and q_line, and then the second gate line driver is repositioned at the top and continues line scanning until all gate lines in a single frame are used, wherein when a line of the normal image is being scanned on one part of a single frame, a line of the dimmed image is scanned on another part of the frame simultaneously, and a dimmed image is defined to be a digitized image in a single frame with 1/N of the original pixel value.

2. The driving method as claimed in claim 1, wherein the number N is a positive integer.

3. The driving method as claimed in claim 1, wherein basing on the selection rule, the gate line driver that works with a data line driver to output a drive voltage for creating a normal image in a single frame is to be a first gate line driver.

4. The driving method as claimed in claim 1, wherein basing on the selection rule, the gate line driver that works with a data line driver to output a drive voltage for creating a dimmed image in the same frame is to be a second gate line driver.

5. The driving method as claimed in claim 1, wherein the number of gate lines respectively connected to the first gate line driver and the second gate line driver is a fixed number.

6. The driving method as claimed in claim 5, wherein the number of lines skipped between a particular line of the normal image and a corresponding line of the dimmed image is to be greater than the fixed number of gate lines.

7. The driving method as claimed in claim 1, wherein the data line driver is connected to a dimmer control line to a receive dimmer signal, such that when the data line driver intends to output the drive voltage for a dimmed image, a dimmer signal is issued to all data registers to cause certain changes in the digitized image temporarily saved in the data registers, such that the pixel value of the digitized image is changed to a fraction 1/N of the original pixel value, so that the data line driver can generate a drive voltage for the required dimmed image.
